(19) United States
(12) Patent Application Publication
(10) Pub. No.: US 2006/0054727 A1
(43) Pub. Date: Mar. 16, 2006

(54) Systems and methods for thermal regulation of shredding device

(76) Inventor: Joseph Y. Ko, Laguna Niguel, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/227,994

(22) Filed: Sep. 15, 2005

Related U.S. Application Data
(60) Provisional application No. 60/610,169, filed on Sep. 15, 2004.

(51) Int. Cl. B02C 18/16

(52) U.S. Cl. 241/236

(57) ABSTRACT

A shredding device capable of continuous operation for an extended period of time. Certain embodiments of the shredding device include multiple fans disposed with a housing that operate to reduce and/or maintain a temperature of a motor that drives a shredding mechanism (e.g., shredding rollers). For example, at least one fan may be directly coupled to the motor. The fans may effect cross-ventilation within the housing and/or expel heated air through one or more ventilation ports of the housing. In certain embodiments, the fans effect airflow in multiple directions within the housing to cool the motor.

### RELATED APPLICATION

This application claims the benefit of priority under 35 U.S.C. § 119(e) of U.S. Provisional Application No. 60/610,169 filed on Sep. 15, 2005, and entitled “SYSTEM AND METHOD FOR THERMAL REGULATION OF SHREDDING DEVICE,” the entirety of which is incorporated herein by reference and is to be considered a part of this specification.

### BACKGROUND OF THE INVENTION

1. Field of the Invention

Preferred embodiments of the invention relate generally to shredding devices, and, in particular, to systems and methods for thermal regulation of a shredding device.

2. Description of the Related Art

Shredding devices are used to aid in paper recycling and/or to prevent dissemination of the information on paper or other materials. Shredding devices are available at both a commercial or industrial level, which shredders are often large and expensive devices capable of receiving large quantities of paper. Consumer-level shredding devices are manufactured for use in homes or small offices. Consumer-sized shredders may be stand-alone devices or may be mountable to the top of a receptacle, such as a trash can. The shredders may have manual feed and/or automatic feed arrangements. These consumer-size shredders also usually have a limited shredding capacity, such as thirty sheets of paper at any one time.

A major problem with traditional consumer-sized shredding devices is overheating. For example, consumer-sized paper shredders can generally continuously shred paper for a limited time, usually five to seven minutes, before overheating, which usually occurs when the shredder motor reaches a temperature of between 75° C. and 80° C. When reaching the “overheating” temperature, which temperature is often defined by safety regulations, the shredder usually has a safety mechanism that causes the shredder (i.e., the motor) to cease functioning while the shredder cools down. This “cool down” period can last up to thirty minutes, during which time the operator must wait before resuming any future shredding activity.

To prevent or reduce overheating, some shredder manufacturers have increased the size of their shredders or use larger motors that do not generate as much heat, at a given load, as do smaller motors. Other manufacturers further limit the amount of material that can be shredded at any given time, so as to not overload the shredder motor. However, larger shredders can be bulky and cumbersome and take up valuable space, especially in a home or office environment. In addition, consumer-sized shredders that have a reduced shredding capacity, or that require a cool down time after a period of continuous shredding, can cause inconvenience to and/or waste valuable time of a user.

### SUMMARY OF THE INVENTION

Accordingly, certain embodiments of the invention disclosed herein include a consumer-sized shredder that is capable of running continuously for an extended period of time without overheating. In an embodiment of the invention, a consumer-sized shredder is disclosed having multiple fans and ventilation openings that provide cross-ventilation to cool a shredder motor. In certain embodiments, a consumer-sized shredder is disclosed that runs continuously at a maximum shredding capacity for at least 24 hours.

In one embodiment, a consumer-sized shredding device is provided for continuous shredding for an extended period of time. The consumer-sized shredding device comprises, among other things, a housing and a motor, shredding rollers, and a plurality of fans disposed within the housing. The housing comprises a feed opening, a discharge opening, and a plurality of ventilation openings, such as, for example, ventilation ports and/or ventilation slots. The motor is capable of driving the shredding rollers so as to cut a material upon contact with the rollers. Each of the plurality of fans is positioned proximate to at least one of the plurality of ventilation openings such that the plurality of fans is capable of causing cross-ventilation within the housing to reduce and/or maintain the temperature of the motor. In a further embodiment of the invention, the shredding device comprises a fan positioned next to the motor.

In one embodiment, the foregoing shredding device is capable of continuous shredding for more than twenty-four hours. In yet another embodiment, the fans cause the motor to operate at a reduced temperature, such as below 70° C. In addition, the fans may be configured to operate only when the motor is operating or when the motor is above a particular temperature, such as may be determined by one or more temperature sensors. In yet another embodiment, the housing is configured to mount on a waste receptacle, such as a trash can.

In another embodiment, a method is provided for manufacturing a consumer-sized shredder capable of continuous shredding for an extended period of time. The method comprises providing a shredder housing having a plurality of ventilation openings, a feed opening and a discharge opening. The method also includes providing at least two shredding rollers and at least one motor capable of driving said shredding rollers to cut material fed through the feed opening. The method further comprises providing a plurality of fans disposed within the housing, wherein at least one of the fans is capable of causing air to flow into the housing through at least one of the ventilations openings and at least a second fan is capable of causing air to flow out of the housing through at least one of the ventilation openings. Such airflow in and out of the housing reduces the temperature of the motor.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates certain inner components of a consumer-sized paper shredder according to an embodiment of the invention.

FIG. 2 illustrates an exemplary cross-ventilation pattern effected by fans of the paper shredder of FIG. 1 to cool a shredder motor.

FIG. 3 illustrates an exemplary fan usable with the paper shredder of FIG. 1.

### DETAILED DESCRIPTION OF THE PREFERRED EMBODIMENTS

The features of the systems and methods will now be described with reference to the drawings summarized above. The drawings, associated descriptions, and specific implementation are provided to illustrate embodiments of the invention and not to limit the scope of the disclosure.

In addition, methods and functions described herein are not limited to any particular sequence, and the acts or states relating thereto can be performed in other sequences that are appropriate. For example, described acts or states may be performed in an order other than that specifically disclosed, or multiple acts or states may be combined in a single act or state.

The term “consumer-sized” as used herein is a broad term and is used in its ordinary sense and is used without limitation to describe apparatuses, devices, systems, and the like, that are generally used in a home or office setting. For example, a “consumer-sized shredder” refers to a shredder that would generally be used in a home or a small office. For instance, a consumer-sized shredder may generally have a smaller shredding capacity (e.g., 30 sheets) than a larger, commercial-sized or industrial-sized shredder.

The term “cross-ventilation” as used herein is a broad term and is used in its ordinary sense and describes, without limitation, the flow or movement of a liquid and/or gas, such as air, across or through a particular area.

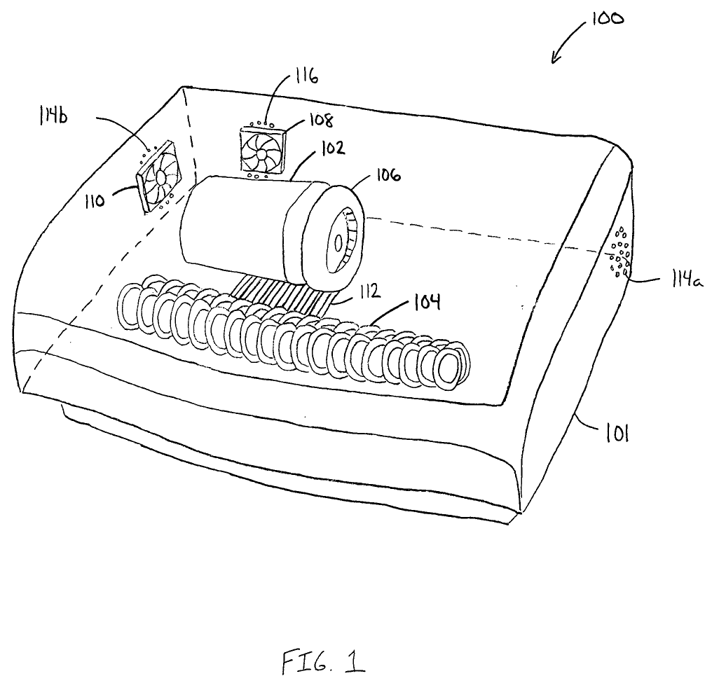

FIG. 1 illustrates an embodiment of a consumer-sized shredding device 100 usable in a home and/or office setting. In certain embodiments, the shredding device 100 is capable of continuous operation over an extended period of time, such as, for example, at least twenty-four hours. Such embodiments advantageously allow a user to continuously shred material, up to a maximum load capacity, without overheating the shredding device 100 and/or without needing to interrupt the shredding process to allow for a “cool down” period for the shredding device 100. In the depicted embodiment, the shredding device 100 is a paper-shredding device that is configured to mount on a top of a waste receptacle or other like container.

In an embodiment, the shredding device 100 has a stated shredding capacity of between 5 and 30 sheets of 20-pound bond paper during a single pass. In a preferred embodiment, the shredding device has a stated capacity of approximately 15 sheets of 20-pound bond paper during a single pass. Other embodiments of the shredding device 100 may have a shredding capacity of less than 5 sheets or of more than 30 sheets. The shredding device 100 may also have a predetermined shred speed of between approximately 5 and approximately 15 feet per minute (FPM), such as approximately 7 FPM. Other embodiments of the shredding device 100 may be configured to shred at a speed less than 5 FPM or greater than 15 FPM or may be adjustable between different shred speeds.

In other embodiments, the shredding device 100 may be configured to shred other types of media or material, such as compact disks, credit cards, floppy disks, cardboard, cardstock, combinations of the same or the like. In yet other embodiments, the shredding device 100 may incorporate a design or structure similar to the paper shredding devices described in U.S. Pat. No. 5,975,445 to Joseph Ko, the entirety of which is hereby incorporated herein by reference. In yet other embodiments of the invention, the shredding device 100 may comprise a stand-alone shredder that does not require an external receptacle.

For ease of illustration and explanation, only certain inner components of the shredding device 100 are shown in FIG. 1 and described herein. A skilled artisan will recognize from the disclosure herein certain wiring, electrical components and/or gear assemblies usable with the shredding device 100.

In particular, the shredding device 100 comprises a housing 101 and a motor 102 that is operatively coupled to a shredding mechanism 104. In certain embodiments, the housing 101 is configured to mount on the top of a standard waste receptacle and/or a customized container. In certain embodiments, the housing 101 substantially encloses the inner components of the shredding device 100 and is of a size that is conducive to home and/or office use. For example, in certain embodiments, the volume of the housing 101 is approximately 0.5 cubic feet. For instance, the housing 101 may have dimensions of approximately 14 inches (width) by approximately 11 inches (depth) by approximately 6 inches (height).

In other embodiments, the dimensions of the shredding device 100 may have a volume of more or less than approximately 0.5 cubic feet. In yet other embodiments of the invention, the shredding device 100 may comprise at least one extendable arm that provides for adjustment of at least one dimension of the housing 101 to allow the shredding device 100 to mount on different-sized or different-shaped containers.

In certain embodiments, the housing 101 preferably comprises a durable material, such as a hard plastic, that protects the inner components of the shredding device 100. The housing 101 may also provide structural support for the inner components, such as by substantially securing the component(s) in certain position(s). In certain embodiments, the housing 101 preferably is able to withstand increased temperatures without substantial warping so as to not cause increased stress to and/or mechanical loads on the inner components, such as the motor 102 and/or the shredding mechanism 104. In certain embodiments, the housing 101 may further comprise side support panels that provide for structural support of the housing 101 and/or that maintain the positioning of the motor 102, the shredding mechanism 104 and/or other components of the shredding device 100. For example, in certain embodiments, the side support panels may comprise metal or a hard plastic.

With continued reference to FIG. 1, the motor 102, when operating, is configured to drive the shredding mechanism 104 to cut material that comes in contact therewith. In certain embodiments, the motor 102 is a DC motor coupled to a power source that provides approximately 115 volts to the motor 102. For example, in certain embodiments, the motor 102 comprises a Model No. SJ8250M115 motor available from Tur-Yih Electric Co: (Guangdong, China).

In yet other embodiments, the motor 102 is configured to operate at a voltage other than 115 volts. The motor 102 may be alternatively configured to be portably powered by batteries contained within or external to the housing 101.

In an embodiment, the motor 102 drives the shredding mechanism 104 through the use of a power transmission system (not shown). For example, the power transmission system may comprise a gear driven system that transfers the revolutions of the motor 102 into a torque used to activate and/or rotate the shredding mechanism 104. In other embodiments of the invention, the power transmission system may comprise a belt or a chain driven system.

As illustrated, the shredding mechanism 104 comprises a plurality of shredding rollers. In particular, each of the shredding rollers comprises a plurality of blades or knife rollers that mesh with each other to cut material, such as paper, into strips. In certain embodiments, the shredding mechanism 104 cuts paper into strips approximately 0.25 inch wide and approximately 1.4 inches long. In other embodiments of the invention, the shredding mechanism 104 may comprise one or more shredding rollers shredding rollers have sharpened edges that are formed in a crisscross pattern to cross-cut of paper into substantially smaller pieces, similar to confetti. Both types of shredding rollers are described in more detail in U.S. Pat. No. 5,975,445.

FIG. 1 further depicts the shredding device 100 as having three fans: a motor fan 106 directly coupled to the motor 102, a rear fan 108 proximate a rear portion of the housing 101, and a side fan 110 proximate a side portion of the housing 101. These fans 106, 108, 110 are advantageously used to regulate the temperature of the motor 102, which process is described in more detail below. In certain embodiments, the operation (e.g., rotation) of the motor 102 causes a corresponding rotation of the motor fan 106. In other embodiments of the invention, the shredding device 100 may comprise a greater or fewer number of fans, and/or at least one of the fans 106, 108, 110 may be positioned in a different location within the shredding device 100.

The illustrated shredding device 100 also comprises a plurality of ventilation openings, including a cooling duct 112 having ventilation slots on a bottom portion of the housing 101, side ventilation ports 114a and 114b on side portions of the housing 101, and a rear ventilation port 116 on a rear portion of the housing 101. In certain embodiments, the cooling duct 112 and ventilation ports 114a, 114b, 116 allow for air to enter and/or exit the housing 101 to cool the inner portion of the shredding device 100, including the motor 102.

In other embodiments of the invention, the shredding device 100 may comprise a greater or fewer number of cooling ducts and/or ventilation ports. For example, the shredding device 100 may comprise only ventilation ports or only cooling ducts. In addition, the cooling ducts and/or ventilation ports may be located in different positions on the housing 101. In yet other embodiments of the invention, at least one fan may be located within an opening of the housing 101.

In certain embodiments of the invention, the rear fan 108 is positioned proximate the rear ventilation port 116, and the side fan 110 is positioned proximate one of the side ventilation ports 114a, 114b. Such positioning allows for the fans 108, 110 to better control the airflow through the ventilation ports. The small size of the fans 108, 110 also allows for the smaller dimensions of the shredding device 100.

In certain embodiments, the fans 106, 108, 110 preferably operate to regulate the temperature of the motor 102 and to prevent overheating. In an embodiment, at least one of the fans 106, 108, 110 operates whenever the motor 102 is operating. In other embodiments, one or more of the fans 106, 108, 110 may be configured to operate when the temperature within the housing 101 reaches a predetermined threshold, such as 70° C. In such an embodiment, at least one of the fans 106, 108, 110 may operate when the motor 102 is not operating.

In addition, in certain embodiments, at least one of the fans 106, 108, 110 may be coupled to, and/or controlled by, control circuitry that includes at least one temperature sensor for determining the temperature of the motor 102, the air within the housing 101, or other components of the shredding device 100. The control circuitry may cause at least one of the fans 106, 108, 110 to operate when the temperature sensor senses a particular temperature or range of temperatures.

The motor 102 is preferably kept at an operating temperature of approximately 64° C. An increase in motor temperature may occur under at least two conditions: (1) when the user operates the shredding device 100 continuously for a prolonged period of time; or (2) when the user attempts to load the shredding device 100 at above the stated maximum load capacity. In addition to the heat regulation process described below with respect to the operation of the fans 106, 108, 110, the shredding device 100 may also include overheat protection circuitry. Such circuitry may be used to turn off the motor 102 if overheating occurs despite the use of fans 106, 108, 110.

Other protection circuitry may also be used with the shredding device 100. For example, in an embodiment, the shredding device 100 may include overload protection circuitry that turns off the motor 102 when the stated load capacity is grossly exceeded and/or when the shredding mechanism 104 jams. Such circuitry protects the motor 102 from overloading the power transmission system, such as a gear or a chain system that drives the shredding mechanism 104. The shredding device 100 may also comprise protection circuitry that automatically turns off the motor 102 when the shredded waste level in the associated waste receptacle exceeds a certain limit. In such an embodiment, the shredding device 100 ceases operating until the waste receptacle is at least partially emptied.

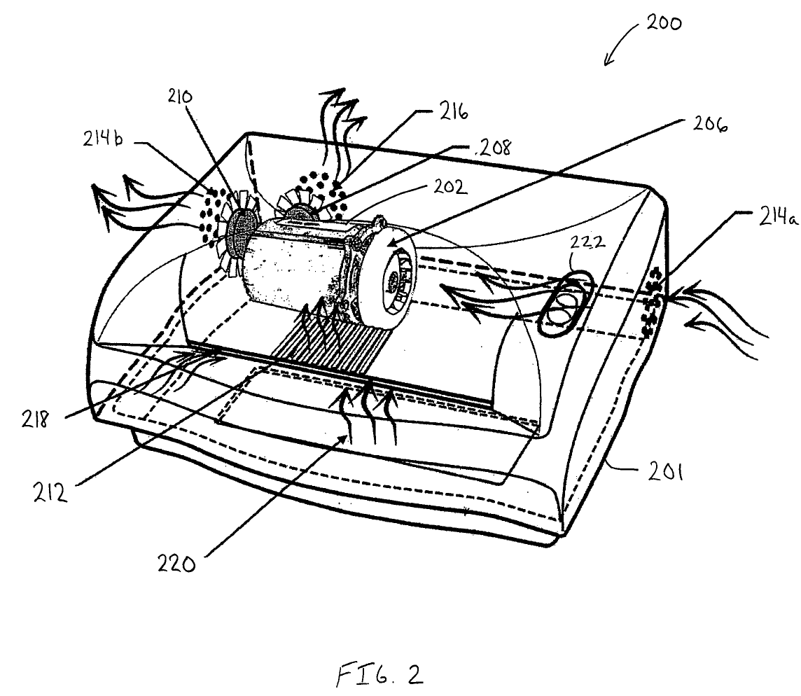

FIG. 2 illustrates a shredding device 200 having components similar to those of the shredding device 100 and having the shredding mechanism removed. To simplify the description, components will not be redescribed in detail if they were described above. Rather, the shredding device 200 components in the embodiment of FIG. 2 will be given a reference numeral that retains the same last two digits as the reference numeral used in connection with FIG. 1, and the last two digits will be preceded with a numeral “2.” For example, motor 202 of the shredding device 200 generally corresponds to the motor 102 of the shredding device 100, and fans 206, 208, 210 generally correspond to the fans 106, 108, 110. Certain features and differences illustrated by the shredding device 200 in FIG. 2 will be illuminated in the following discussion.

In particular, the illustrated shredding device 200 additionally depicts a feed opening 218 to allow the input of material into the shredding device 200. As shown, the feed opening 218 includes an elongated slot on a top portion of a housing 201 and allows for manual insertion of paper to be shredded. In other embodiments of the invention, the shredding device 200 may include structure and/or devices for the automatic feeding of paper into the feed opening 218. For example, the feed opening 218 may be coupled to or be part of a feed tray with feed rollers that advance paper and/or other material into the feed opening 218.

Also shown is a discharge opening 220 structured to allow for the dispensing of the shredded paper or medium into another receptacle, such as a waste container. The illustrated discharge opening 220 comprises an elongated slot located in a bottom portion of the housing 201 such that shredded waste falls into a container on which the shredding device 200 is mounted.

The feed opening 218 and/or discharge opening 220 advantageously provide locations though which air may enter and/or exit the housing 201. For example, FIG. 2 further illustrates an exemplary cross-ventilation pattern effected by the positioning of the fans 206, 208, 210, which direct airflow through the housing 201. Such movement of air over the motor 202 advantageously causes cooling, such as by convection, within the housing 201. For example, air outside the housing 201, which air is generally cooler than the air inside the housing 201, is drawn into the housing 201 through the feed opening 218, the discharge opening 220, the cooling duct 212 and/or the side ventilation port 214a by rotation of the motor fan 206, the rear fan 208 and/or the side fan 210. This cooler air drawn from outside the housing 201 advantageously reduces the temperature inside the housing 201.

In certain embodiments, the heated air within the housing 201 may be expelled by rotation of rear fan 208 and/or the side fan 210. As illustrated, heated air is expelled through the side ventilation port 214b by the side fan 210 and is expelled through the rear ventilation port 216 by the rear fan 208. Expelling the heated air in these directions also advantageously avoids disrupting the normal use of the shredding device 200. That is, the heated air expelled from the housing 201 of the shredding device 200 is not being directed into locations, such as near the feed opening 218, wherein the user and/or paper is present during normal use of the shredding device 200.

In other embodiments of the invention, other ventilation patterns may be created by the use of more or fewer fans, by reversing and/or selectively switching the rotation of at least one of the fans 208, 210, or by positioning the fans 208, 210 and/or the ventilation ports 214a, 214b, 216 in different locations on the housing 201. For example, instead of having ventilation patterns that run generally the width of the housing 201 from right to left (as depict in FIG. 2) and the height of the housing 201 from bottom to top, the ventilation patterns may run left to right and/or from top to bottom, or the patterns may be in a diagonal direction. Furthermore, in certain embodiments, one fan may be used for primarily drawing air into the housing 201, and another fan may be used for primarily expelling air from the housing 201.

In certain embodiments of the invention, the cross-ventilation created by the fans 206, 208, 210 allows for the continuous operation of the shredding device 200 at a stated maximum load capacity, such as 15 sheets of 20-pound paper, for a period of at least twenty-four hours. This configuration is advantageously useful in an environment of high volume shredding. This configuration also advantageously provides for thermal regulation of the motor 202 without having to increase the size of the motor 202 and/or the housing 201, and/or without needing to reduce the maximum stated load capacity of the shredding device 200.

In other embodiments of the invention, other heat dissipation structures, designs and/or methods may be used in conjunction with, or in place of, at least one of the mechanical fans 206, 208, 210 described above. For example, the shredding device 200 may incorporate heat sinks, fluid-based radiator systems and/or other combinations of heat dissipation designs.

With continued reference to FIG. 2, the illustrated shredding device 200 further comprises a control switch 222. In certain embodiments, the control switch 222 controls the power applied to the motor 202. In certain embodiments, the control switch 222 manages the direction and/or speed at which the shredding mechanism (not shown) of the shredding device 200 operates. For example, the control switch 222 may be used to select between a forward shredding mode and a reverse mode.

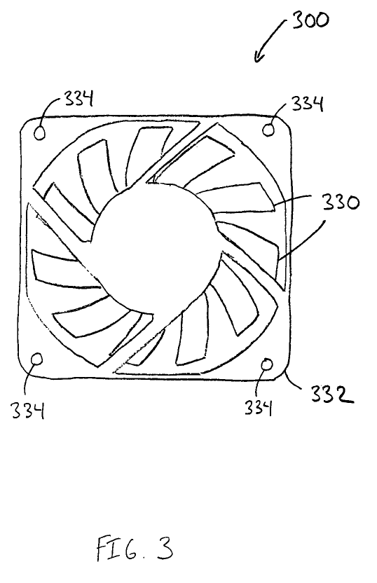

FIG. 3 illustrates an exemplary embodiment of a fan 300 usable with the shredding devices 100 and 200. For example, the fan 300 may be used as the rear fans 108, 208 and/or as the side fans 110, 210. In certain embodiments, the fan 300 comprises multiple blades 330. For example, the blades 330 may comprise a durable material such as, for example, a hard plastic or metal. Furthermore, other embodiments of the fan 300 may include a different number of fan blades 330, and/or the fan blades 330 may comprise a different shape, than what is depicted in FIG. 3.

As shown, the fan 300 comprises a casing 332 that substantially surrounds the fan blades 330. In certain embodiments, the casing 332 comprises a hard plastic. The casing 332 further includes multiple securing holes 334 configured to receive an attachment device, such as a screw or a bolt, to affix the fan 300 to an object, such as the housing of a shredder device. In certain embodiments, the casing 332 has a size of approximately 2 inches by 2 inches by 0.5 inch.

In certain embodiments, the fan 300 is a Model No. DF1205SH fan available from Dynatron Corporation. In certain embodiments, the fan 300 advantageously operates at a relatively low noise level so as to not disrupt individuals using or near the shredding device. For example, the fan 300 may operate at less than 30 dBA, and more preferably, at a maximum noise level of approximately 28 dBA.

In certain embodiments, the fan 300 operates at a speed of approximately 5000 RPM and produces an airflow of approximately 12.5 cubic feet per minute (CPM). In yet other embodiments, other sizes, speeds and/or airflow characteristics of the fan 300 may vary depending on at least one of the following: the size of the associated shredding device, the size of the motor, the location of the fan 300, the input power characteristics, combinations of the same and the like.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A consumer-sized shredding device capable of continuous shredding for an extended period of time, the consumer-sized shredding device comprising:
a plurality of shredding rollers;
a motor configured to drive the plurality of shredding rollers to cut a material upon contact with the shredding rollers;
a housing having a top portion and a bottom portion and substantially enclosing the plurality of shredding rollers and the motor, the housing further comprising a plurality of ventilation openings;
a feed opening in the top portion of the housing and configured to receive the material;
a discharge opening in the bottom portion of the housing and configured to allow cut portions of the material to exit the housing; and
a plurality of fans disposed within the housing and configured to effect multiple directions of airflow into and out of the housing to decrease the temperature of the motor.

2. The consumer-sized shredding device of claim 1, wherein the plurality of ventilation openings comprises a plurality of ventilation ports.

3. The consumer-sized shredding device of claim 2, wherein the plurality of ventilation ports comprises:
a first ventilation port disposed in a first side portion of the housing; and
a second ventilation port disposed in a rear portion of the housing.

4. The consumer-sized shredding device of claim 3, wherein the plurality of fans further comprises:
a first fan positioned proximate the first ventilation port; and
a second fan positioned proximate the second ventilation port.

5. The consumer-sized shredding device of claim 4, further comprising a third ventilation port disposed in a second side portion of the housing, wherein said second side portion is positioned opposite of the first side portion.

6. The consumer-sized shredding device of claim 2, further comprising ventilation slots.

7. The consumer-sized shredding device of claim 6, wherein the ventilation slots are disposed on the bottom portion of the housing.

8. The consumer-sized shredding device of claim 1, wherein the plurality of fans comprises a fan operatively coupled to the motor.

9. A consumer-sized shredding system capable of thermal regulation, the consumer-sized shredding system comprising:
a shredding mechanism configured to cut material coming in contact therewith;
a motor operatively coupled to the shredding mechanism to drive the shredding mechanism;
a housing substantially enclosing the shredding mechanism and the motor, the housing further comprising a plurality of ventilation openings; and
a plurality of fans disposed within the housing and, when operating, configured to decrease the temperature of the motor by effecting cross-ventilation within the housing.

10. The consumer-sized shredding system of claim 9, wherein the plurality of fans further comprises:
a first fan configured to expel air through a first ventilation opening on a side portion of the housing; and
a second fan configured to expel air through a second ventilation opening on a rear portion of the housing.

11. The consumer-sized shredding system of claim 10, wherein the plurality of fans further comprises a motor fan directly coupled to the motor.

12. The consumer-sized shredding system of claim 11, wherein rotation of the motor causes a corresponding rotation of the motor fan.

13. The consumer-sized shredding system of claim 12, wherein the plurality of ventilation openings further comprises a third ventilation opening on a bottom portion of the housing.

14. The consumer-sized shredding system of claim 9, further comprising a waste receptacle on which the housing mounts.

15. The consumer-sized shredding system of claim 9, further comprising a sensor configured to monitor the temperature of the motor.

16. A method for manufacturing a consumer-sized shredder capable of continuous shredding for an extended period of time, the method comprising:
providing a shredder housing having a plurality of ventilation openings;
providing at least two shredding rollers;
providing at least one motor capable of driving the at least two shredding rollers so as to cut material coming in contact therewith; and
providing a plurality of fans within the housing, the plurality of fans configured to reduce a temperature of the motor by causing airflow in multiple directions within the housing.

17. The method of claim 16, wherein providing the plurality of fans comprises providing each of the plurality of fans proximate one of the plurality of ventilation openings.

18. The method of claim 17, wherein the plurality of ventilation openings comprises a first ventilation port on a side portion of the housing and a second ventilation port on a rear portion of the housing.

19. The method of claim 16, wherein providing the plurality of fans comprises providing a fan operatively coupled to the motor.

20. The method of claim 16, further comprising providing control circuitry configured to power off the motor when the motor reaches a predetermined temperature.
